(19) United States
(12) Patent Application Publication
(10) Pub. No.: US 2014/0270147 A1
(43) Pub. Date: Sep. 18, 2014

(54) SYSTEM AND METHOD FOR A PREDICTIVE CUSTOMER EXPERIENCE

(71) Applicant: Capital One Financial Corporation, McLean, VA (US)

(72) Inventors: Marcus E. WILLIAMS, Murfreesboro, TN (US); Laughton W. NUCKOLS, Glen Allen, VA (US); William H. BURNET, Maidens, VA (US)

(73) Assignee: Capital One Financial Corporation, McLean, VA (US)

(21) Appl. No.: 14/204,155

(22) Filed: Mar. 11, 2014

Related U.S. Application Data
(60) Provisional application No. 61/778,805, filed on Mar. 13, 2013.

(51) Int. Cl. H04M 3/51

(52) U.S. Cl. CPC H04M 3/5166; H04M 3/5183
USPC 379/266.07

(57) ABSTRACT

Systems and methods for identifying a customer include storing account information, the account information including one or more associated phone numbers and an account number, the account number having a last 4-digit portion, receiving a phone number, comparing the phone number to the account information of various account holders to determine whether the phone number matches an associated phone number, prompting the user to input 4 digits if there is a match, and comparing the received 4 digits to the respective 4-digit portion to identify the customer.

### CROSS-REFERENCE TO RELATED APPLICATIONS

This application claims priority to U.S. Provisional Patent Application No. 61/778,805, filed on Mar. 13, 2013, the entire contents of which are incorporated herein by reference.

### FIELD OF THE DISCLOSURE

The present disclosure relates to systems and methods for providing predictive customer experience.

### BACKGROUND OF THE DISCLOSURE

Currently, it is difficult to easily identify customers that do not provide their account number when communicating with a provider. For example, without a 16-digit credit card account number, it is difficult to easily identify a credit card account customer over the phone and/or using an Interactive Voice Response (IVR) unit. If an account number is not provided, there is a significant risk that the customer will be routed to the incorrect department. These and other drawbacks exist.

### SUMMARY OF THE DISCLOSURE

Systems and methods for identifying a customer include storing account information, the account information including one or more associated phone numbers and an account number, the account number having a last 4-digit portion, receiving a phone number, comparing the phone number to the account information of various account holders to determine whether the phone number matches an associated phone number, prompting the user to input 4 digits if there is a match, and comparing the received 4 digits to the respective 4-digit portion to identify the customer.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts a schematic diagram of an exemplary system for providing a predictive customer experience, according to an exemplary embodiment of the disclosure;

FIG. 2 depicts a flow diagram illustrating an exemplary method for abbreviated identification according to an embodiment of the disclosure;

FIG. 3 depicts a flow diagram illustrating an exemplary method for abbreviated identification according to an embodiment of the disclosure;

FIG. 4 depicts a flow diagram illustrating an exemplary method for abbreviated identification according to an embodiment of the disclosure;

FIG. 5A depicts a flow diagram illustrating an exemplary method for fraud routing according to an embodiment of the disclosure;

FIG. 5B depicts a flow diagram illustrating an exemplary method for fraud routing according to an embodiment of the disclosure; and

FIG. 6 depicts a flow diagram illustrating an exemplary method for high value service routing according to an embodiment of the disclosure.

### DETAILED DESCRIPTION OF THE EMBODIMENTS

The following description is intended to convey a thorough understanding of the embodiments described by providing a number of specific exemplary embodiments and details involving systems and methods for providing a predictive customer experience. It should be appreciated, however, that the present disclosure is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs. A financial institution and system supporting a financial institution are used as examples for the disclosure. The disclosure is not intended to be limited to financial institutions only.

FIG. 1 depicts an exemplary embodiment of a system 100 for providing a predictive customer experience, according to various embodiments of the disclosure. As referred to herein, by way of example, a predictive customer experience may refer to an experience where a customer's request is routed to a customer service agent that is most likely to assist the customer based on the customer's account status. For example, a customer may communicate with a service provider, such as a financial institution, via a phone channel, online and/or mobile channel or in person. A predictive customer experience would ensure that the customer in that channel is routed to the customer service most likely to respond to the customer's needs. Where a customer's account number is long or otherwise difficult to remember, the customer may not be easily identifiable. As described herein, the predictive customer experience may use abbreviated identification to more easily identify that customer and appropriately route that customer.

A predictive customer experience may also attempt to identify high value service customers and route those customers to customer services specifically targeted for high value service clients. For example, a high value service customer may be multi-product and/or high spend customers. Accordingly, where the customer is a financial institution customer, a high value service customer may be a customer with a credit card, bank account, retirement account, and/or other financial services accounts and/or a customer who meets certain spending thresholds (e.g., $1000/month on a credit card). In exemplary embodiments, a high value service customer may attempt to abort an IVR system, for example, and fail to identify themselves. The predictive customer experience would attempt to identify the high value service customer and route them to the high value service agents instead of the core customer service center.

A predictive customer experience may also attempt to identify customers using fraud case data to determine whether a customer has an open fraud case and route that customer to a fraud queue. Fraud cases may refer to cases relating to fraudulent transactions, identity fraud/theft and/or fraudulent payments. The predictive customer experience could use the fraud case data to determine the particular type of fraud case and route the customer to the correct customer service agent.

System 100 may include various network-enabled computer systems, including, as depicted in FIG. 1 for example, a financial institution 101 and a user device 107. Financial Institution 101 may include account database 102 which may store account information, account processor 103, interactive voice response unit (IVR) 104, web services 105 which may include online and mobile web services, and agent desktop services 106.

As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The network-enabled computer systems may execute one or more software applications to, for example, receive data as input from an entity accessing the network-enabled computer system, process received data, transmit data over a network, and receive data over a network. The one or more network-enabled computer systems may also include one or more software applications to enable the creation and provisioning of an account holder's mobile budget application.

The components depicted in FIG. 1 may store information, including account information, in various electronic storage media, such as, for example, account database 102. Electronic information, files, and documents may be stored in various ways, including, for example, a flat file, indexed file, hierarchical database, relational database, such as a product database created and maintained with software from, for example, Oracle® Corporation, Microsoft® Excel file, Microsoft® Access file, or any other storage mechanism.

The components depicted in FIG. 1 may be coupled via one or more networks, such as, for example, network 108. Network 108 may be one or more of a wireless network, a wired network or any combination of wireless network and wired network. For example, network 108 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11b, 802.15.1, 802.11n and 802.11g or any other wired or wireless network for transmitting and receiving a data signal.

In addition, network 108 may include, without limitation, telephone lines, fiber optics, IEEE Ethernet 902.3, a wide area network (“WAN”), a local area network (“LAN”), or a global network such as the Internet. Also network 108 may support an Internet network, a wireless communication network, a cellular network, or the like, or any combination thereof. Network 108 may further include one network, or any number of the exemplary types of networks mentioned above, operating as a stand-alone network or in cooperation with each other. Network 108 may utilize one or more protocols of one or more network elements to which they are communicatively coupled. Network 108 may translate to or from other protocols to one or more protocols of network devices. Although network 108 is depicted as a single network, it should be appreciated that according to one or more embodiments, network 108 may comprise a plurality of interconnected networks, such as, for example, the Internet, a service provider's network, a cable television network, corporate networks, and home networks.

In various exemplary embodiments, an account holder may be associated with a user device 107. An account holder may be any individual or entity that desires to conduct a financial transaction, including receiving customer service, relating to one or more accounts held at one or more financial institutions. Also, an account holder may be a computer system associated with or operated by such an individual or entity. An account may include any place, location, object, entity, or other mechanism for holding money or performing transactions in any form, including, without limitation, electronic form. An account may be, for example, a credit card account, a prepaid card account, stored value card account, debit card account, check card account, payroll card account, gift card account, prepaid credit card account, charge card account, checking account, rewards account, line of credit account, credit account, mobile device account, an account or service that links to an underlying payment account already described, or mobile commerce account. A financial institution may be, for example, a bank, other type of financial institution, including a credit card provider, for example, or any other entity that offers accounts to customers. An account may or may not have an associated card, such as, for example, a credit card for a credit account or a debit card for a debit account. The account may enable payment using biometric authentication, or contactless based forms of authentication, such as QR codes or near-field communications. The account card may be associated or affiliated with one or more social networking sites, such as a co-branded credit card. Although the example described herein relates to a financial institution, the inventive concepts herein may be applied to other customer service providers that receive customer service requests via phone, online, mobile, and agent channels, for example.

As used herein, the term mobile device may be, for example, a handheld PC, a phone, a smartphone, a PDA, a tablet computer, or other device. The mobile device may include Near Field Communication (NFC) capabilities, which may allow for communication with other devices by touching them together or bringing them into close proximity. Exemplary NFC standards include ISO/IEC 18092:2004, which defines communication modes for Near Field Communication Interface and Protocol (NFCIP-1). For example, a mobile device may be configured using the Isis Mobile Wallet™ system, which is incorporated herein by reference. Other exemplary NFC standards include those created by the NFC Forum.

As described in reference to FIG. 1, financial institution 101 may provide an account holder with one or more financial accounts. The financial account may be associated with the account holder's one or more mobile devices. The mobile device may be configured to act as a method of payment at a POS location (not shown) using, for example, NFC or any other mobile payment technology. When an account holder uses his mobile device at a POS location to perform a financial transaction, the financial transaction may be charged to the mobile payment account. For example, the account holder may use the device in lieu of a credit card to make a purchase merchant. The purchase would then be charged to the mobile payment account associated with the account holder device 107. The mobile payment account may be stored in a mobile payment account database at financial institution 101. The account may be a traditional credit card account where the account holder uses a credit card, rewards card, debit card, or similar method of payment to purchase goods and services from one or more merchants 107.

As described in reference to FIG. 1, account processor 103 may be configured to receive and process requests on behalf of the financial institution from the account holder's mobile device via network 108 and/or from the IVR 104, web services 105 and agent desktop services 106, for example.

Account database 102 may store account information. Although depicted herein as a singular database, account database may include one or more databases. Account information may include, for example, personal information relating to a customer, such as a name, address, age, social security number and/or the like. Account information also may include a phone number associated with the account holder, an account number and other unique identifiers that may identify the account holder. For example, an account number may be a 16-digit credit card account number. Account information may also include information that may identify an account holder as a high value service customer. Account information also may include fraud case data which may describe any open fraud cases (e.g., fraudulent transactions, identity theft, and fraudulent payments and/or the like) associated with an account holder.

IVR 104 may include computer systems that allow customers to interact with a financial institution's host system via a telephone keypad or by speech recognition, after which the customer can service inquiries by following the IVR dialogue. IVR systems can respond with prerecorded or dynamically generated audio to further direct users on how to proceed. IVR applications can be used to control almost any function where the interface can be broken down into a series of simple interactions. A call center associated with financial institution 101 may use IVR system 104 to identify and segment callers. The ability to identify customers allows financial institution services, for example, to be tailored according to a customer profile. The caller can be given the option to wait in the queue, choose an automated service, or request a callback, for example. The IVR system may obtain caller line identification (CLI) data from the network to help identify or authenticate the caller. Caller line identification may refer to a telephone service, available in analog and digital phone systems, including voice over Internet Protocol (VoIP) applications, that transmits a caller's number to the called party's telephone equipment, such as IVR 104, during the ringing signal, or when the call is being set up but before the call is answered. Where available, caller ID can also provide a name associated with the calling telephone number. The information made available to the called party may be displayed on a telephone's display, on a separately attached device, or be processed by an attached computer with appropriate interface hardware (e.g., IVR 104). Similarly, IVR 104 may utilize automatic number identification (ANI). ANI may refer to a feature of telephony intelligent network services that permits subscribers to display or capture the billing telephone number of a calling party. In the United States it is part of Inward Wide Area Telephone Service (WATS).

Web services 105 may refer to web-related services offered by financial institution 101, including, without limitation, online account servicing and mobile account servicing. By way of example, web services 105 may include the hardware and software for provision of a web site on behalf of financial institution 101 and/or the hardware and software for provision of a mobile application on behalf of financial institution 101. Where web services are used to provide a predictive customer experience, a MAC address associated with a user device 107, for example, may be used to identify a user in lieu of caller line information (as described below).

Agent desktop services 106 may refer to services offered by a financial institution agent using a desktop. By way of example, agent desktop services 106 may include the hardware and software for provision of an agent desktop that may allow an agent to provide customer service to a customer. Agent desktops may be deployed in, for example, financial institution branches and/or call centers.

FIG. 2 depicts a flow diagram illustrating an exemplary method for abbreviated identification according to an embodiment of the disclosure. This exemplary method is provided by way of example. The method 200 shown in FIG. 2 can be executed or otherwise performed by one or more combinations of various systems. The method 200 as described below may be carried out by the system for providing a predictive customer experience as shown in FIG. 1, by way of example, and various elements of that system are referenced in explaining the method of FIG. 2. Each block shown in FIG. 2 represents one or more processes, methods, or subroutines in the exemplary method 200.

Referring to FIG. 2, abbreviated identification may utilize the customer's automatic number identification (ANI), CLI or other telephone number identification information in conjunction with a database of account/phone number relationships to identify a caller that is believed to be calling so that the financial institution can identify the user using the last 4 digits of the user's account number. In other words, a financial institution can provide a predictive customer experience based on the combination of the customer's phone number (as retrieved from the ANI, for example) and the last four digits of the customer's account number (instead of requiring the customer to input the full 16-digit account number into the IVR). As illustrated in FIG. 2, using method 200, a customer may call into an IVR, and if ANI call data is available, use only last 4 digits of the customer's account to identify the customer. If, for example, ANI information and the 4-digit combination are not available, the customer may be identified using the full 16-digit account number, for example.

As illustrated in block 201, a customer may call a financial institution, which may answer using an interactive voice response unit (IVR). For example, a customer may call using a mobile device, voice over IP application, landline or the like, and an IVR may answer the call on behalf of the financial institution. In block 202, the financial institution may determine whether ANI is available in the call data. If so, method 200 may proceed to block 203. If not, method 200 may proceed to block 208.

In block 203, a financial institution may determine whether the ANI passes an ANI anti-spoofing check. In so doing, the financial institution may determine whether the ANI has been spoofed or misrepresented. If the ANI passes the anti-spoofing check, method 200 may proceed to block 204. If not, method 200 may proceed to block 208.

In block 204, the financial institution may determine whether any ANI matches to accounts in the financial institution database. To make this determination, the financial institution may search account records to determine whether one or more records is associated with the ANI. If there is a match, method 200 may proceed to block 205. If not, method 200 may proceed to block 208.

In block 205, the financial institution may determine whether there are two plastics with the same last 4 digits. For example, if there are two account records associated that have the same last 4 digits, the financial institution, via, for example, an IVR, may prompt the customer to input the last 4 digits to correctly identify the plastic associated with the call. In block 207, the IVR may present one of the scripts illustrated in FIGS. 3 and 4 to the customer. One of ordinary skill in the art will appreciate that other similar scripts may be presented.

In block 208, the financial institution may require 16 digit identification and resort to standard call flow if ANI 4 digit identification cannot be accomplished.

FIGS. 3 and 4 depict flow diagrams 300 and 400, respectively, each illustrating exemplary methods for abbreviated identification according to embodiments of the disclosure. As illustrated in FIGS. 3 and 4, various sample dialogs may be used for abbreviated identification.

FIGS. 5A and 5B depict a flow diagram 500 illustrating an exemplary method for fraud routing according to an embodiment of the disclosure. This exemplary method is provided by way of example. The method 500 shown in FIG. 5 can be executed or otherwise performed by one or more combinations of various systems. The method 500 as described below may be carried out by the system for providing a predictive customer experience as shown in FIG. 1, by way of example, and various elements of that system are referenced in explaining the method of FIG. 5. Each block shown in FIG. 5 represents one or more processes, methods, or subroutines in the exemplary method 500.

Referring to FIGS. 5A and 5B, the exemplary method 500 may utilize fraud case data to identify customers with open fraud cases and route them to the appropriate fraud queue within the financial institution call center, for example. For example, method 500 may enable detection of the correct type of fraud case and transfer the customer to an agent that handles that type of fraud case.

As shown in FIG. 5, in block 501, a customer calls and successfully authenticates itself to, for example, the financial institution.

In block 502, the financial institution uses, for example, the authentication information or other account information to determine whether a fraud ID transaction case is opened. If yes, method 500 may proceed to block 503. If no, method 500 may proceed to block 504.

In block 503, the financial institution may assume business as usual (BAU) and direct the call to the IVR.

In block 504, the financial institution may determine whether there is a fraud identity associated with the call. If yes, method 500 may proceed to block 505. If no, method 500 may proceed to block 509.

In block 509, the financial institution may determine whether the customer's card is working. If yes, method 500 may proceed to block 506. If no, method 500 may proceed to block 507.

In block 506, a message associated with a card that is not working may be presented.

In block 507, a message associated with a card working may be presented.

In block 508, the call may be routed to the fraud identity center or team.

In block 509, the financial institution may determine whether a priority score associated with the customer is greater than a threshold amount, such as, for example, 950 as shown in FIG. 5. If yes, method 500 may proceed to block 522. If no, method 500 may proceed to block 510.

In block 510, the financial institution may assume business as usual (BAU) and direct the call to the IVR.

In block 511, the financial institution may determine whether the call is self-service eligible. If yes, method 500 may proceed to block 512. If no, method 500 may proceed to block 523.

In block 512, the financial institution may determine whether a toll free number (TFN) associated with fraud was dialed. If yes, method 500 may proceed to block 513. If no, method 500 may proceed to block 514.

In block 513, the financial institution may validate the customer's social security number (and/or date of birth), using for example, the IVR to prompt the customer and receive input.

In block 514, the financial institution may validate security information associated with a card of the customer. For example, as shown in FIG. 5, the financial institution may validate the card verification value (CVV2) code. The financial institution may validate the CVV2 using, for example, the IVR.

In block 515, the financial institution may, using for example the IVR, perform a fraud review and present a fraud review preface and introduction message to the customer.

In block 516, the financial institution may, using for example the IVR, inform the customer of certain transaction details. For example, the financial institution may present various transactions to the customer via, for example, the IVR.

In block 517, the financial institution determines whether the customer recognizes all of the transactions presented in block 516. To make this determination, the financial institution may prompt the user via the IVR. If yes, method 500 may proceed to block 518. If no, method 500 may proceed to block 521.

In block 518, transaction status may be updated. For example, the financial institution may update an account associated with the user that the user recognizes all of the presented transactions and fraud therefore is unlikely.

In block 519, a fraud review closing (outro) message may be played to the customer via, for example, the IVR.

In block 520, method 500 may end.

In block 521 transaction status may be updated. For example, the financial institution may update an account associated with the user that the user does not recognize all of the presented transactions and fraud therefore is likely.

In block 522, the call may be routed for further fraud processing.

In block 523, the financial institution may determine whether a case is still open. If yes, method 500 may proceed to block 524. If no, method 500 may proceed to block 529.

In block 524, the financial institution may determine whether a card (e.g., a credit or debit card) associated with the customer is still working. If yes, method 500 may proceed to block 525. If no, method 500 may proceed to block 526.

In block 525, the financial institution may determine whether a toll free number (TFN) associated with fraud was dialed. If yes, method 500 may proceed to block 526. If no, method 500 may proceed to block 527.

In block 526, an existing fraud agent introduction message may be provided to the customer.

In block 527, a new, card working fraud agent introduction message may be provided to the customer.

In block 528, the call may be routed for fraud transaction processing.

In block 529, the financial institution may determine whether a toll free number (TFN) associated with fraud was dialed. If yes, method 500 may proceed to block 530. If no, method 500 may proceed to block 528.

In block 530, a “no fraud” message may be provided to the customer via, for example, the IVR.

In block 531, the call may be sent back to customer service for business as usual IVR interaction.

In block 532, the financial institution's toll free number (TFN) associated with fraud matters may pick up a customer call, using, for example, an IVR.

In block 533, a fraud welcome message may be provided to the customer via, for example, the IVR.

In block 534, the customer may successfully authenticate to the financial institution. Method 500 may then proceed to block 511.

FIG. 6 depicts a flow diagram illustrating an exemplary method for high value service routing according to an embodiment of the disclosure. This exemplary method is provided by way of example. The method 600 shown in FIG. 6 can be executed or otherwise performed by one or more combinations of various systems. The method 600 as described below may be carried out by the system for providing a predictive customer experience as shown in FIG. 1, by way of example, and various elements of that system are referenced in explaining the method of FIG. 6. Each block shown in FIG. 6 represents one or more processes, methods, or subroutines in the exemplary method 600.

Referring to FIG. 6, the exemplary method 600 may utilize ANI and account/phone number relationships to determine if a customer that refuses or fails to provide identity in the IVR is a high value service customer.

As shown in block 601, a customer may call in from an ANI associated with a high value spend (HVS) account. As referred to herein, an HVS account may relate to a high spend small business, partnership cards, micro affinities, bank VIPs or multi-product customers of the financial institution or the like. In block 602, a financial institution may use, for example an IVR to identify the customer. If successful, method 600 may proceed to block 603. If unsuccessful, method 600 may proceed to block 604. In block 603, the call may be processed by, for example the IVR as business as usual. In block 604, the call may be routed to an HVS queue.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

We claim:

1. A system comprising:
an account database storing account information, the account information including one or more associated phone numbers and an account number, the account number having a last 4-digit portion;
an interactive voice response unit that receives a phone number; and
a processor that compares the phone number to the account information of various account holders to determine whether the phone number matches an associated phone number,
wherein, if there is a match, the interactive voice response unit prompts the user to input 4 digits, and the processor then compares the received 4 digits to the respective 4-digit portion to identify the customer.

2. The system of claim 1, wherein the 4 digits are the last four digits of a card associated with the customer.

3. The system of claim 2, wherein the card is a credit card.

4. The system of claim 2, wherein the card is a debit card.

5. The system of claim 1, further comprising a fraud processor that enables fraud investigation of an account associated with the received 4 digits.

6. A method of identifying a customer, comprising:
storing account information, the account information including one or more associated phone numbers and an account number, the account number having a last 4-digit portion;
receiving a phone number;
comparing the phone number to the account information of various account holders to determine whether the phone number matches an associated phone number, prompting the user to input 4 digits if there is a match; and
comparing the received 4 digits to the respective 4-digit portion to identify the customer.

7. The method of claim 6, wherein the 4 digits are the last four digits of a card associated with the customer.

8. The method of claim 7, wherein the card is a credit card.

9. The method of claim 7, wherein the card is a debit card.

10. The method of claim 6, further comprising investigating, using an interactive voice response unit and a fraud processor, an account associated with the received 4 digits.
